(19) United States
(12) Patent Application Publication
(10) Pub. No.: US 2018/0160611 A1
(43) Pub. Date: Jun. 14, 2018

(54) AGRICULTURAL IMPLEMENT WITH TINES

(71) Applicant: CNH Industrial America LLC, New Holland, PA (US)

(72) Inventors: William J. Dietrich, SR., Goodfield, IL (US); Dean A. Knobloch, Tucson, AZ (US)

(73) Assignee: CNH Industrial America LLC, New Holland, PA (US)

(21) Appl. No.: 15/372,846

(22) Filed: Dec. 8, 2016

(51) Int. Cl. A01B 23/02; A01B 19/00

(52) U.S. Cl. CPC A01B 23/02; A01B 19/00

(57) ABSTRACT

An agricultural implement includes a chassis; a hitch connected to the chassis and defining a longitudinal axis; and a tine harrow carried by the chassis and including a plurality of tines. At least one of the tines includes a vertically extending main body; a first tooth connected to the main body and extending laterally in a first lateral direction relative to the longitudinal axis; and a second tooth connected to the main body and extending laterally in a second lateral direction relative to the longitudinal axis which is opposite to the first lateral direction.

### BACKGROUND OF THE INVENTION

### 1. Field of the Invention

The present invention relates to agricultural implements, and, more particularly, to tillage implements with harrows having tines.

### 2. Description of the Related Art

A wide variety of tillage implements are used to prepare soil for planting. Some such implements include two or more sections articulated to one another so as to perform multiple functions as they are pulled through fields by a single tractor or other prime mover. One such implement is a cultivator/harrow, which is capable of simultaneously tilling soil and leveling the tilled soil in preparation for planting. This implement includes a cultivator that is towed by a tractor or other prime mover, and a unitary or sectional tine harrow that is towed by the cultivator.

The cultivator includes a plurality of cultivator members or “sweeps” (sometimes known as shanks or chisel plows) that are suspended from a frame and that rip into the soil as the machine is pulled across the ground to till the soil. The sweeps are arranged in transversely extending rows. The sweeps of each row are transversely staggered relative to the sweeps of the adjacent rows. In use, each successive row of sweeps tills part of a strip of soil left untilled by the preceding row. The last row of sweeps tills the last untilled strip of the swath, leaving ridges between the sweeps that are flanked by valleys directly behind the sweeps.

The harrow is designed to level the tilled soil sufficiently to produce a seedbed that is as level as possible and that is relatively clod free. A clod free, level seedbed formed from soil of relatively small particle size is desirable because it facilitates planting to a uniform depth and, accordingly, promotes uniform germination and uniform emergence. The typical harrow includes a plurality of ground-engaging tines that penetrate the soil tilled by the cultivator. Multiple harrow sections are often provided, each of which spans a proportionate part of the transverse width of the swath tilled by cultivator. The tines are typically arranged in longitudinally extending, transversely spaced rows. They are intended to redirect soil from ridges or windrows left by the cultivator sweeps into the adjacent valleys, hence leveling the tilled surface. The tines, and/or related equipment such as rotating baskets, also firm the soil and break up clods.

As the prime mover carries the sweeps and tines at relatively high speeds of greater than 5 miles per hour, the rear sweeps' plowing behavior is intensified to create large mounds of soil as the cultivator is carried across the field. As the sweeps are carried at ever-increasing speeds, the formed mounds of soil have become so large that known tines of the harrow have not been particularly effective at leveling the soil due to the relatively large mounds of soil being formed at higher speeds.

What is needed in the art is a cultivator which can more dependably level tilled soil at increasingly high speeds.

### SUMMARY OF THE INVENTION

The present invention provides an agricultural implement with a harrow tine including at least one tine which has a pair of laterally extending teeth that extend in opposite directions relative to each other.

The invention in one form is directed to an agricultural implement including a chassis; a hitch connected to the chassis and defining a longitudinal axis; and a tine harrow carried by the chassis and including a plurality of tines. At least one of the tines includes a vertically extending main body; a first tooth connected to the main body and extending laterally in a first lateral direction relative to the longitudinal axis; and a second tooth connected to the main body and extending laterally in a second lateral direction relative to the longitudinal axis which is opposite to the first lateral direction.

An advantage of the present invention is the teeth of the tine can laterally move the soil as the implement advances to better level the soil.

Another advantage is the teeth can be adjusted in a variety of ways to adapt to various different soil conditions.

Yet another advantage is the tine formed according to the present invention provides a relatively simple and inexpensive solution to a known problem which has not been satisfactorily addressed by known cultivators.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a top view of an embodiment of an agricultural implement formed according to the present invention;

FIG. 2 is a side view of the agricultural implement shown in FIG. 1;

FIG. 3 is a rear view of the agricultural implement shown in FIGS. 1-2 with an embodiment of a tine formed according to the present invention;

FIG. 4 is a rear view of another embodiment of a tine formed according to the present invention;

FIG. 5 is a rear view of yet another embodiment of a tine formed according to the present invention;

FIG. 6 is a rear view of yet another embodiment of a tine formed according to the present invention;

FIG. 7 is a rear view of yet another embodiment of a tine formed according to the present invention which includes a digging portion;

FIG. 8 is a rear view of yet another embodiment of a tine formed according to the present invention which includes a digging portion;

FIG. 9 is a rear view of yet another embodiment of a tine formed according to the present invention which includes a digging portion;

FIG. 10 is a rear view of yet another embodiment of a tine formed according to the present invention which includes a digging portion; and

FIG. 11 is a cross-sectional view of the tine shown in FIG. 10 taken along line 11-11;

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

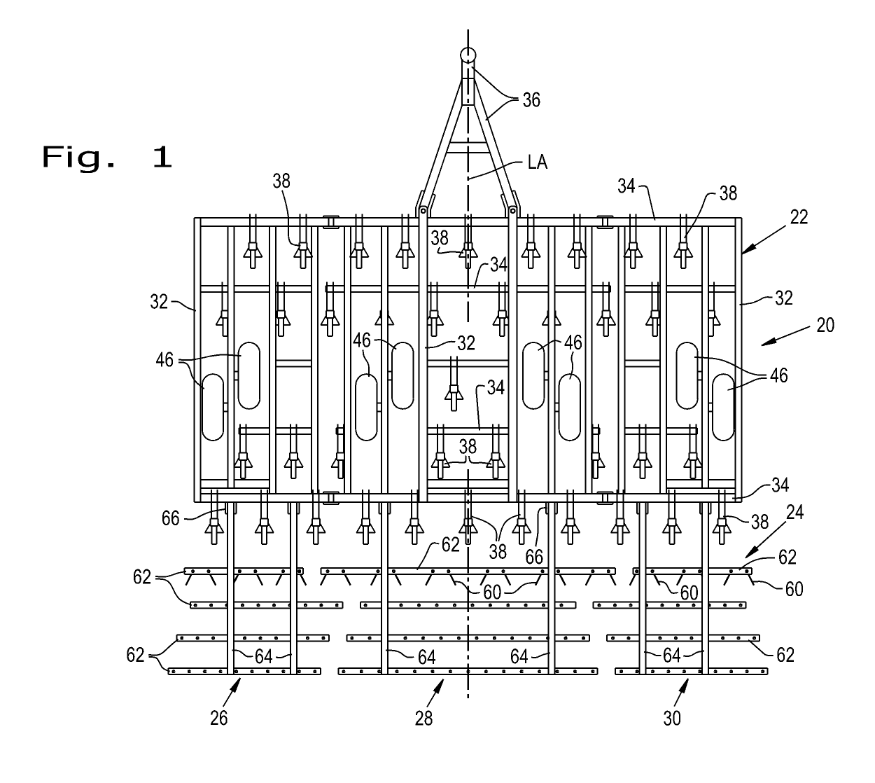

Referring now to the drawings, and more particularly to FIGS. 1-2, there is shown an embodiment of an agricultural implement 20 formed according to the present invention which includes a cultivator 22 and a tine harrow 24 articulated to one another in an end-to-end fashion. The cultivator 22 is configured to be towed by a tractor or other prime mover so as to till the soil over which the implement 20 travels. The harrow 24 is towed by the cultivator 22 and is configured to level windrows or ridges left by the cultivator 22. The harrow 24 can be formed to have a plurality (3 in the illustrated embodiment) of harrow sections 26, 28, 30 independently articulated to the back of the cultivator 22. The center harrow section 28 of the illustrated embodiment is wider than the two flanking end sections 26 and 30. However, different numbers of harrow sections of different relative widths, or even a single harrow section spanning the width of the swath tilled by the cultivator 22, could be provided if desired.

The cultivator 22 is conventional. It includes a frame formed from longitudinal tubular beams 32 and transverse tubular beams 34, a hitch 36 that couples the frame to a prime mover (not shown) and defines a longitudinal axis LA, and a plurality of cultivator members in the form of shank assembly 38 or plows that extend downwardly from the transverse beams 34 to the ground. As best seen in FIG. 2, each shank assembly 38 can include a curved arm 40 mounted on the associated transverse beam 34 and a sweep 42 mounted on the bottom end of the arm 40. The arms 40 can be pivotally mounted on the transverse beams 34 and be biased to the rearward-most positions thereof by springs 44. A plurality of wheels 46 can be mounted on arms 48 that are pivotable with respect to the frame. The arms 48 can be coupled to a hydraulic cylinder 50 by a suitable linkage 52 that raises and lowers the arms 48 upon cylinder extension and retraction. The wheels 46 therefore can be raised from their illustrated, lowermost position to either 1) a partially raised position to reduce the penetration depth of the shank assembly 38 or 2) a fully raised position for transport.

The shank assembly 38 of successive rows of the illustrated cultivator 22 can be indexed relative to the lines of travel of the sweeps of the remaining rows to affect a so-called “split the middle” sweep pattern, which allows for uniform ridges to be formed. The shank assembly 38 ahead of the rear two rows of sweeps take a full cut and leave alternating strips of untilled soil. The shank assembly 38 of the two rear rows till the untilled strips left by the forward sweeps. Specifically, the sweeps in the next to last row till one half of the width of the remaining untilled strips and take out the middle of the ridges left by the sweeps in the row directly in front of that row. The shank assembly 38 of the rear row till the other half of the untilled strips and fill the grooves left by the next to last row of sweeps and take out the middle of the ridge left by the sweeps of the third row, resulting in a groove behind each of the shank assembly 38 of the rear row and a ridge adjacent each groove.

Except for being of different widths, the harrow sections 26, 28, 30 can identical to one another. The following description of harrow section 30 therefore applies equally to sections 26 and 28.

Referring to FIG. 2, the harrow section 30 includes a plurality of tines 60 and a frame that supports the tines 60. The frame can include a plurality (4 in the illustrated embodiment) of tine bars 62 that support the tines 60 in longitudinally spaced, transversely extending rows, and 2) a pair of longitudinally extending support arms 64. The frame can be coupled to the cultivator by a pair of floating hitch assemblies or any other suitable manner that allows the tines 60 to engage the soil as the implement 20 travels across a field.

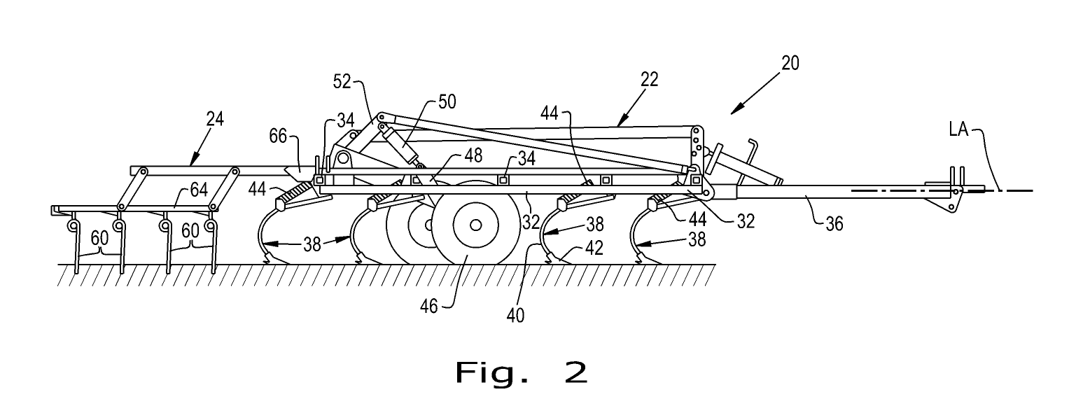

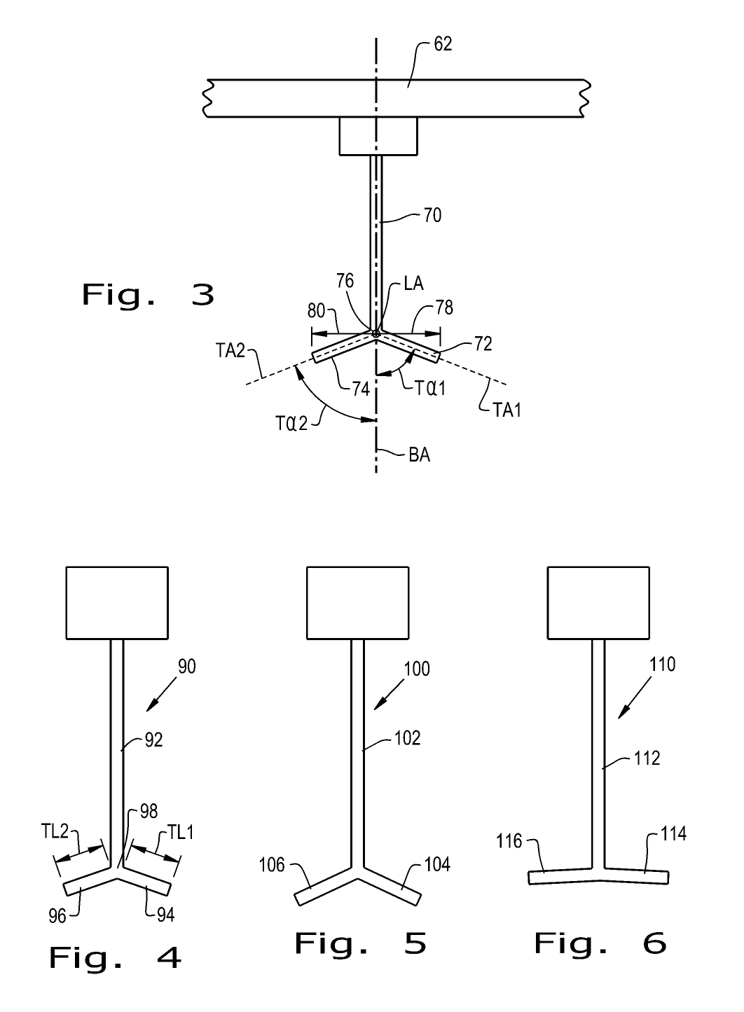

Referring specifically now to FIG. 3, a better view of one of the tines 60 shown in FIGS. 1-2 is shown. As can be seen, the tine 60 has a main body 70 which extends in a vertical direction from the tine bar 62, i.e., toward the ground, so the tine 60 can engage the soil. While the main body 70 of the tine 60 is shown extending substantially vertical, i.e., a body axis BA defined by the main body 70 is perpendicular to the ground, it should be appreciated that the main body 70 may also vertically extend at a non-perpendicular angle relative to the ground. When the main body 70 is substantially vertical, the body axis BA can be perpendicular to the longitudinal axis LA, or an axis parallel to the longitudinal axis LA, defined by the hitch 36, which can be seen in FIG. 3.

The tine 60 also includes a first tooth 72 connected to the main body 70 and a second tooth 74 connected to the main body 70. As shown in FIG. 3, the first tooth 72 and second tooth 74 can both connect to a joining region 76 of the main body 70 which defines an end of the main body 70, but this is an optional configuration. The first tooth 72 extends from the main body 70 in a first lateral direction, indicated by arrow 78, which is lateral relative to the longitudinal axis LA defined by the hitch 36 and the second tooth 74 extends from the main body 70 in a second lateral direction, indicated by arrow 80, which is also lateral relative to the longitudinal axis LA defined by the hitch 36 but extends oppositely to the first lateral direction 78 of the first tooth 72. As can be seen, the first tooth 72 can define a first tooth axis TA1 and the second tooth 74 can define a second tooth axis TA2, with the tooth axes TA1 and TA2 forming acute tooth angles Tα1, Tα2 with the body axis BA of the main body 70, i.e., one or both of the teeth 72, 74 can extend from the main body 70 at a non-perpendicular angle relative to the body axis BA. As shown in FIG. 3, the tooth angles Tα1, Tα2 of the first tooth 72 and second tooth 74, respectively, are both approximately 70° relative to the body axis BA, but it is contemplated that one or both of the tooth angles Tα1, Tα2 can be in a range between 10° and 80° relative to the body axis BA. Further, while the tooth angles Tα1, Tα2 of the first tooth 72 and second tooth 74, respectively, are shown as being equal in FIG. 3, it should be appreciated that this is optional and having teeth extending form the main body 70 at different angles might be desired in certain configurations. Further, when the hitch 36 defines a front of the implement 20, as shown, the teeth 72, 74 can extend rearwardly from the main body 70, i.e., in a direction away from the hitch 36.

As the implement 20 travels across a field, the hitch 36, which links the implement 20 to the prime mover, roughly approximates the travel path of the implement 20. In this sense, the implement 20, and the carried tines 60, travel in line and/or parallel with the longitudinal axis LA defined by the hitch 36 as the implement 20 is carried across the field. As the implement 20 is carried across a field, the shank assemblies 38 create mounds of soil. As the tines 60 can be carried by the implement 20 behind the shank assemblies 38, the teeth 72, 74 of the tines 60 extending laterally relative to the longitudinal axis LA act to break up the mounds created by the shank assemblies 38 as the tines 60 pass the mounds. The teeth 72, 74 break up the mounds by disrupting and laterally displacing the soil of the mounds as the implement 20 travels, causing the volume of soil in the mounds to more evenly spread across the field, creating a more level soil profile. It has been found that by including the teeth 72, 74 extending laterally from the main body 70 in opposite lateral directions 78 and 80, respectively, the tines 60 of the tine harrow 24 are able to better level and finish the soil, even at speeds which are greater than, for example, 5 miles per hour.

From the foregoing description, it should be appreciated that many different configurations of tines can be formed according to the present invention to take advantage of the leveling capability provided by two oppositely directed, laterally extending teeth. Referring now to FIGS. 4-6, a few example embodiments of tines formed according to the present invention are shown. As can be seen in FIG. 4, an embodiment of a tine 90 is shown with a main body 92, a first tooth 94 extending from the main body 92 in one lateral direction, and a second tooth 96 extending from the main body 92 in a lateral direction oppositely relative to the first tooth 94. The teeth 94 and 96 can both be connected to a joining region 98 of the main body 92 by, for example, welding the teeth 94, 96 to the joining region 98, with the joining region 98 defining an end of the main body 92. Each tooth 94, 96 can have a respective tooth length TL1, TL2 with the tooth lengths being approximately equal, as shown. When the tine 90 is connected to the tine bar 62, the main body 92 will extend vertically, similarly to the main body 70 of the tine 60.

Referring to FIG. 5, another embodiment of a tine 100 formed according to the present invention is shown which is similar to the tine 90 shown in FIG. 4. As can be seen, the tine 100 has a main body 102, a first tooth 104 extending from the main body 102 in one lateral direction, and a second tooth 106 extending from the main body 102 in a lateral direction oppositely relative to the first tooth 104. As can be seen, the first tooth 104 and second tooth 106 extend from the main body 102 at similar angles compared to the teeth 94, 96 of the tine 90, with the teeth 104, 106 of the tine 100 having greater lengths than the teeth 94, 96 of the tine 90. When the tine 100 is connected to the tine bar 62, the main body 102 will extend vertically, similarly to the main body 70 of the tine 60.

Referring to FIG. 6, yet another embodiment of a tine 110 formed according to the present invention is shown which is similar to previously described tines. The tine 110 includes a main body 112, a first tooth 114 extending from the main body 112 in one lateral direction, and a second tooth 116 extending from the main body 112 in a lateral direction oppositely relative to the first tooth 114. As can be seen, the teeth 114 and 116 extend from the main body 112 at larger acute angles relative to the main body 112, compared to the tines shown in FIGS. 3-5. When the tine 110 is connected to the tine bar 62, the main body 112 will extend vertically, similarly to the main body 70 of the tine 60.

While the tines shown in FIGS. 3-6 include a joining region which defines an end of a main body, there are some instances when it may be desired to have a portion of the main body below the joining region in order to dig into the soil as the implement 20 travels across a field. Referring now to FIGS. 7-9, embodiments of such tines are shown.

Referring specifically to FIG. 7, an embodiment of a tine 120 formed according to the present invention is shown which includes a main body 122, a first tooth 124 extending from the main body 122 in one lateral direction, and a second tooth 126 extending from the main body 122 in a lateral direction oppositely relative to the first tooth 124. As can be seen, the teeth 124, 126 both connect to a joining region 128 of the main body 122 of the tine 120 by, for example, welding. However, unlike the tines shown in FIGS. 3-6, the tine 120 shown in FIG. 7 includes a digging portion 130 that, when the tine 120 is connected to the tine bar 62, extends below the joining region 128. In this sense, the digging portion 130 can define the end of the main body 122 to engage the soil as the implement 20 travels across a field, producing a ridge in the soil during travel. The digging portion 130 can have a digging portion length DL1 between an end 132 of the digging portion 130 and the joining region 128 which defines how into the soil the digging portion 130 can dig into the ground during travel of the implement 20 across a field. The digging portion length DL1 can be adjusted in order to adjust the depth of the ridge that will be formed in the soil during travel of the implement 20 across the field. In other aspects, the tine 120 operates and can be adjusted in various ways as previously described.

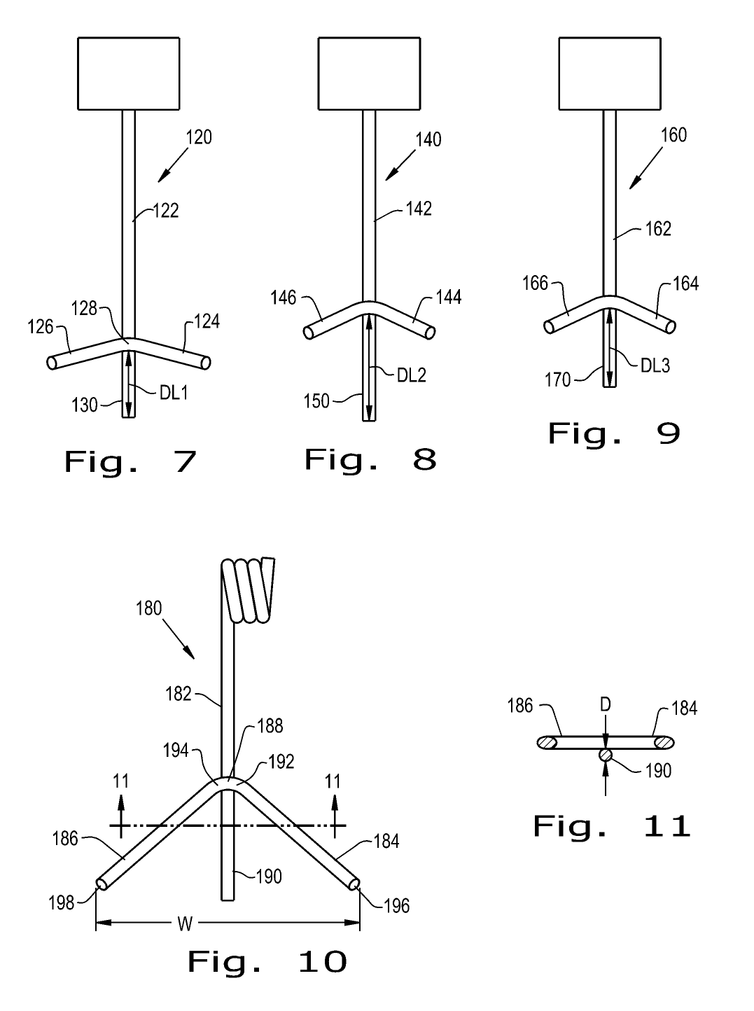

Referring to FIG. 8, another embodiment of a tine 140 formed according to the present invention is shown which includes a main body 142, a first tooth 144 extending from the main body 142 in one lateral direction, and a second tooth 146 extending from the main body 142 in a lateral direction oppositely relative to the first tooth 144. The tine 140 is similar to the tine 120 shown in FIG. 7, but has a digging portion 150 with a greater digging portion length DL2 than the digging portion 130 shown in FIG. 7.

Referring to FIG. 9, yet another embodiment of a tine 160 formed according to the present invention is shown which includes a main body 162, a first tooth 164 extending from the main body 162 in one lateral direction, and a second tooth 166 extending from the main body 162 in a lateral direction oppositely relative to the first tooth 164. The tine 160 is similar to the tines 120 and 140 shown in FIGS. 7-8, but has a digging portion 170 with a different digging portion length DL3 than the digging portions 130, 150 shown in FIGS. 7 and 8.

Referring now to FIGS. 10-11, yet another embodiment of a tine 180 formed according the present invention is shown which includes a main body 182, a first tooth 184 extending from the main body 182 in one lateral direction, and a second tooth 186 extending from the main body 182 in a lateral direction oppositely relative to the first tooth 184. As can be seen, the tine 180 also has a digging portion 190 extending below a joining region 188 to which both teeth 184, 186 connect. Each tooth 184, 186 has a respective connected end 192, 194 which connects to the joining region 188 by, for example, welding and a free end 196, 198 opposite the respective connected ends 192, 194. As can be seen, the free ends 196, 198 define a width W of the tine 180 therebetween, with the width W representing the lateral extension of both teeth 184, 186 relative to the main body 182. As shown in FIGS. 10-11, the width W of the tine 180, and all previously described tines, can be quite large, such as 16″, but may also be as small as 1″ or 2″, depending on the desired application of the tine. The width W of a tine formed according to the present invention, therefore, can be in a range between 1″ and 16″.

To form the tine 180 and all other previously described tines, and referring specifically now to FIG. 11, the main body 182, the first tooth 184 connected to the main body 182, and the second tooth 186 connected to the main body 182 can all be formed as metal rods defining a round, such as circular, cross-section of diameter D. When formed as metal rods, the main body 182, first tooth 184, and second tooth 186 can all be welded together using standard techniques to form the tine 180 and previously described tines. Alternatively, tines can be formed according to the present invention using other fabrication techniques, such as casting. It should also be appreciated that while the tines are previously described as being formed of a metal material, the tines formed according to the present invention can be formed of any material that is suitable for working and moving soil as the implement 20 travels across a field, including various polymers and ceramics. As shown in FIG. 11, the main body 182, first tooth 184, and second tooth 186 can all have the same diameter D to define the same cross-sectional area when formed as similar shapes. The diameter D of the main body 182, first tooth 184, and/or second tooth 186 can be varied as desired, with diameters D of between 0.125″ and 1.25″ having been found useful for leveling the soil as the implement 20 travels across a field. It should be appreciated, however, that the main body, first tooth, and second tooth of the tine do not need to have the same shape and/or cross-sectional area, with such parameters being adjustable as desired.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An agricultural implement, comprising:
a chassis;
a hitch connected to said chassis and defining a longitudinal axis; and
a tine harrow carried by said chassis and including a plurality of tines, at least one of said tines including:
a vertically extending main body;
a bar connected to the main body, the bar forming a reverse V-shape, including
a first tooth forming a portion of the reverse V-shape of the bar and extending both laterally and downward in a first lateral direction relative to said longitudinal axis; and
a second tooth forming another portion of the reverse V-shape of the bar and extending both laterally and downward in a second lateral direction relative to said longitudinal axis which is opposite to said first lateral direction,
wherein each first tooth and second tooth extends downward below the main body and are spaced-apart relative to each other, and
wherein an apex of the bar is connected to the main body, and the apex is formed as a rounded curve.

2. The implement according to claim 1, wherein a portion of the main body extends below the bar and forms a digging portion, and the first tooth and the second tooth are each spaced-apart therefrom, such that a gap is formed between the first tooth and the digging portion of the main body, and another gap is formed between the second tooth and the digging portion of the main body.

3. The implement according to claim 1, wherein said main body defines a body axis at least one of said first tooth and said second tooth extending from said main body at a non-perpendicular angle relative to said body axis, and wherein said non-perpendicular angle is in a range between 10° and 80° relative to said body axis.

4. The implement according to claim 2, wherein a reverse V-shape is formed by the first tooth and the diging portion, and a reverse V-shape is formed by the second tooth and the digging portion.

5 and 6: (cancelled).

7. The implement according to claim 1, wherein said first tooth defines a first tooth length and said second tooth defines a second tooth length which is equal to said first tooth length.

8. The implement according to claim 1, wherein said hitch defines a front of said implement and said first tooth and said second tooth both extend rearwardly from said main body.

9. The implement according to claim 1, wherein at least one of said main body, said first tooth, and said second tooth defines a circular cross-section.

10. The implement according to claim 9, wherein said circular cross section defines a diameter between 0.125″ and 1.25″.

11. The implement according to claim 9, wherein said main body, said first tooth, and said second tooth each define a circular cross-section of equal diameter.

12. The implement according to claim 1, wherein said first tooth has a first unconnected end which is not connected to said main body and said second tooth has a second unconnected end which is not connected to said main body, said first unconnected end and said second unconnected end defining a width therebetween, wherein said width is in a range between 1″ and 16″.

13. (canceled).
